(19) United States
(12) Patent Application Publication
(10) Pub. No.: US 2011/0284515 A1
(43) Pub. Date: Nov. 24, 2011

(54) CLOTH MEMBER

(75) Inventors: Fumitoshi AKAIKE, Miyoshi-shi (JP); Akari TAKAHASHI, Kasugai-shi (JP); Takahiro HARITA, Toyota-shi (JP)

(73) Assignee: TOYOTA BOSHOKU KABUSHIKI KAISHA, Aichi-ken (JP)

(21) Appl. No.: 13/107,343

(22) Filed: May 13, 2011

(30) Foreign Application Priority Data
May 18, 2010 (JP) 2010-114126

(51) Int. Cl. H05B 1/00

(52) U.S. Cl. 219/211

(57) ABSTRACT

A cloth member is provided. The cloth member includes a conductive wire configured to generate heat by applying electric current, and a plane-shaped connecting member having conductivity. The conductive wire has an exposed part that is exposed to an outside from the cloth member at a part in a longitudinal direction of the wire. The place-shaped connecting member is folded to sandwich the exposed part of the conductive wire therebetween such that folded surfaces of the connecting member are surface-adhered with each other integrally with the exposed part to be electrically connected to the exposed part.

### BACKGROUND OF THE INVENTION

1. Field of the Invention

The present invention relates to a cloth member, more particularly, to a cloth member having a conductive wire configured to generate heat by applying electric current

2. Description of the Related Art

JP-A No. 2007-227384 describes a fabric covering member (cloth member) including conductive threads braided therein as means for heating a seating surface of a vehicle seat. The conductive threads are braided to extend in a seat width direction of the covering material and are provided in line in the front and rear direction of the seat, so that the threads can heat a seating surface over a wide range thereof. Each of the conductive threads is electrically connected to a plane-shaped connecting member that is connected over the threads and has conductivity, and is enabled to apply electric current by the connecting member, thereby generating heat.

In the above related art, the connecting member is electrically connected to the conductive threads in the cloth member by heat fusion. In this case, non-conductive threads, which are a main constitutional element of the cloth member, become a hindrance, so that a connection resistance of the connecting member and the conductive threads could increase.

### SUMMARY OF THE INVENTION

Accordingly, it is an aspect of the present invention to provide a cloth member which can electrically connect a conductive wire in the cloth member and a connecting member having connectivity so that a connection resistance therebetween is reduced.

According to an illustrative embodiment of the present invention, there is provided a cloth member comprising: a conductive wire configured to generate heat by applying electric current; and a plane-shaped connecting member having conductivity, wherein the conductive wire has an exposed part that is exposed to an outside from the cloth member at a part in a longitudinal direction of the wire, and wherein the place-shaped connecting member is folded to sandwich the exposed part of the conductive wire therebetween such that folded surfaces of the connecting member are surface-adhered with each other integrally with the exposed part to be electrically connected to the exposed part.

According to the above configuration, the connecting member is configured such that the folded surfaces sandwiching the exposed part therebetween are integrally surface-adhered each other. Thus, the wide adhering surface is secured, so that the adhered state, in which the exposed part is sandwiched between the folded surfaces, is kept as stable. Accordingly, it is possible to electrically connect the connecting member and the conductive wire so that the connection resistance therebetween is reduced.

In the above cloth member, a plurality of conductive wires may be aligned in a specific direction within a plane of the cloth member, each conductive wire having an exposed part exposed from an edge part of the cloth member, and the plane-shaped connecting member may extend over the respective exposed parts of the conductive wires and may be folded in the longitudinal direction of the respective conductive wires such that the folded surfaces of the connecting member are surface-adhered with each other integrally with the respective exposed parts of the conductive wires to be electrically connected to the exposed parts.

According to the above configuration, the connecting member has such an elongated shape that it extends over the exposed parts of the conductive wires, is folded in the longitudinal direction of the respective conductive wires and is integrally surface-adhered with the respective exposed parts. Accordingly, compared to a configuration where the connecting member is folded and surface-adhered in the direction, along which the conductive wires are arranged, it is possible to fold the connecting member in a smaller space and to electrically connect the exposed parts of the respective conductive wires in a lump.

In the above cloth member, the exposed part of the conductive wire may be folded back between the folded surfaces of the connecting member such that a length of the exposed part in the longitudinal direction is reduced.

According to the above configuration, the exposed part of the conductive wire is provided between the folded surfaces of the connecting member with being folded back so that a protruding degree (length) of the exposed part is reduced. Thus, even when the exposed part is lengthened to secure a wide contact area with the connecting member, it is possible to make the entire folded length, which is required for the connecting member, small and thus to compactly arrange the connecting member to the cloth member.

### BRIEF DESCRIPTION OF THE DRAWINGS

In the accompanying drawings:

FIG. 1 is a perspective view of a vehicle seat to which a cloth member of a first illustrative embodiment is applied;

FIG. 2 is a partial projection view of the cloth member;

FIG. 3A is a partial enlarged view showing a step of manufacturing a cloth member, and FIG. 3B is a sectional view taken along a line of FIG. 3A;

FIG. 4A is a partial enlarged view showing another step of manufacturing a cloth member, and FIG. 4B is a sectional view taken along a line IV-IV of FIG. 4A;

FIG. 5A is a partial enlarged view showing another step of manufacturing a cloth member, and FIG. 5B is a sectional view taken along a line V-V of FIG. 5A;

FIG. 6A is a partial enlarged view showing a step of manufacturing a cloth member of a second illustrative embodiment, and FIG. 6B is a sectional view taken along a line VI-VI of FIG. 6A; and

FIG. 7A is a partial enlarged view showing a step of manufacturing a cloth member, and FIG. 7B is a sectional view taken along a line VII-VII of FIG. 7A.

### DETAILED DESCRIPTION

Hereinafter, illustrative embodiments of the present invention will be described with reference to the drawings.

### First Illustrative Embodiment

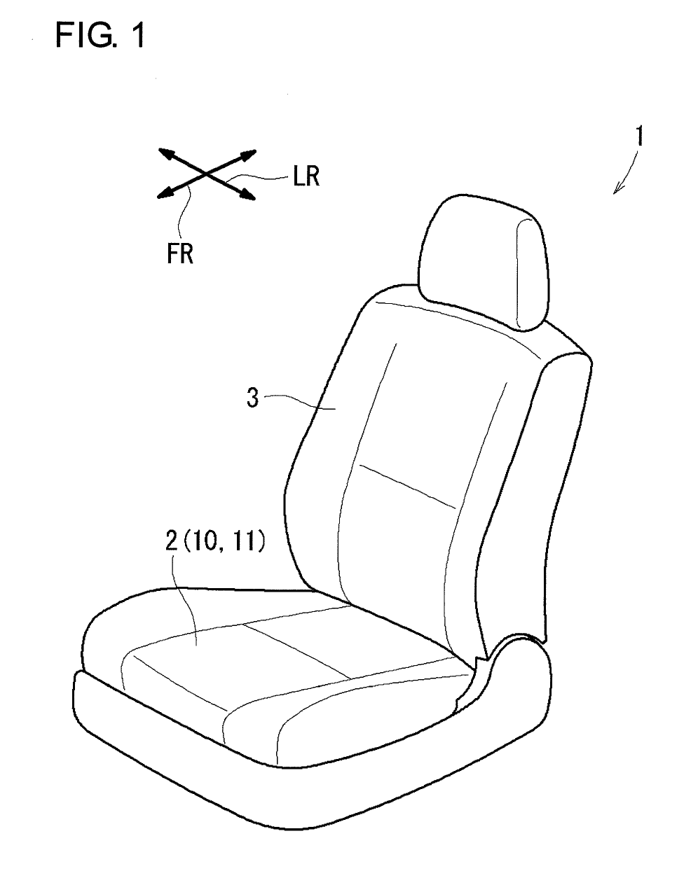

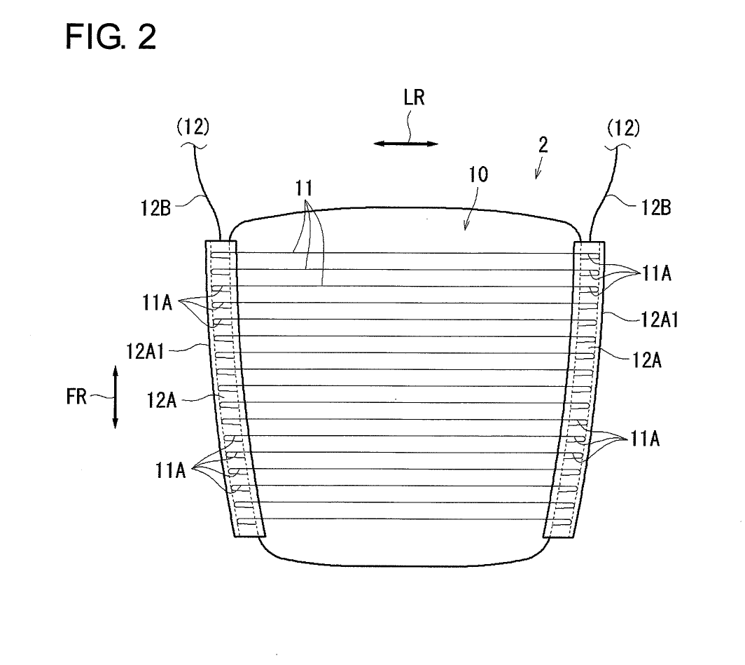

First, a configuration of a cloth member 10 of a first illustrative embodiment will be described with reference to FIGS. 1 to 5B. The cloth member 10 of this illustrative embodiment is configured as a covering material that configures a seating surface of a seat cushion 2 of a vehicle seat 1, as shown in FIGS. 1 and 2. The cloth member 10 has a plurality of conductive wires 11 therein, which can conduct electric current to thus generate heat, and serves as a heater by enabling the respective conductive wires 11 to conduct the electric current and to thus generate heat.

As shown in FIG. 2, the conductive wires 11 are respectively arranged to straightly extend in a seat width direction LR within the cloth member 10 and are provided in the front-rear direction FR of the seat in the cloth member 10. The conductive wires 11 are configured by twisting filaments (conductive threads) of carbon fiber into a bundle. It is noted that, the conductive wires 11 may be also made of conductive threads of metal or alloy, or plated wires or may be configured by twisting the wires into bundles.

The cloth member 10 is configured by weaving false twist yarns of polyethylene terephthalate (PET). Alternatively, the cloth member 10 may be configured by woven fabrics, knitted materials, nonwoven fabrics or braids made of wires of various insulating fibers or may be leather. The insulating fibers may include plant or animal based natural fibers, chemical fibers made of thermoplastic or thermosetting resins or mixed fibers thereof.

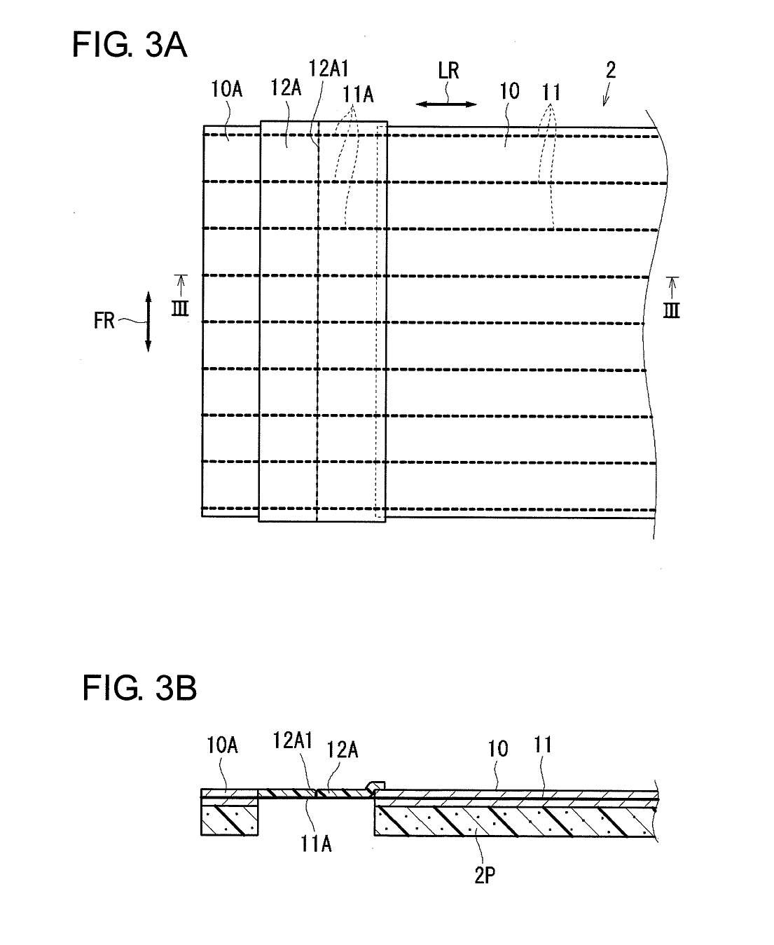

The conductive wires 11 are inserted at a predetermined interval when wires of the cloth member 10 are braided at braiding and making the cloth member 10, so that they are embedded in the cloth member 10. It is noted that the conductive wires 11 may be attached on a backside of the cloth member 10. The backside of the cloth member 10 is provided with a pad material 2P (refer to FIG. 3) and a backside base fabric (not shown). As shown in FIG. 2, the cloth member 10 enables the respective conductive wires 11 to conduct the electric current and to thus generate heat by an electric current applying unit 12 that is electrically connected to the respective conductive wires 11, thereby serving as a heater. At this time, it is preferable to electrically connect the respective conductive wires 11 and the electric current applying unit 12 so that a connection resistance therebetween is reduced.

In the followings, a configuration for electrically connecting the respective conductive wires 11 and the electric current applying unit 12 so that a connection resistance therebetween is reduced will be specifically described. As shown in FIG. 3A and 3B, a plane part of the cloth member 10 between a main body part and an edge part 10A is heat-melted and removed by laser irradiation, and parts (exposed parts 11A) of the respective conductive wires 11 are respectively exposed to the outside at the removed part. It is noted that the means for removing a part of the cloth member 10 may include mechanically removing means such as punch or scissors, in addition to the above optically heating means such as laser.

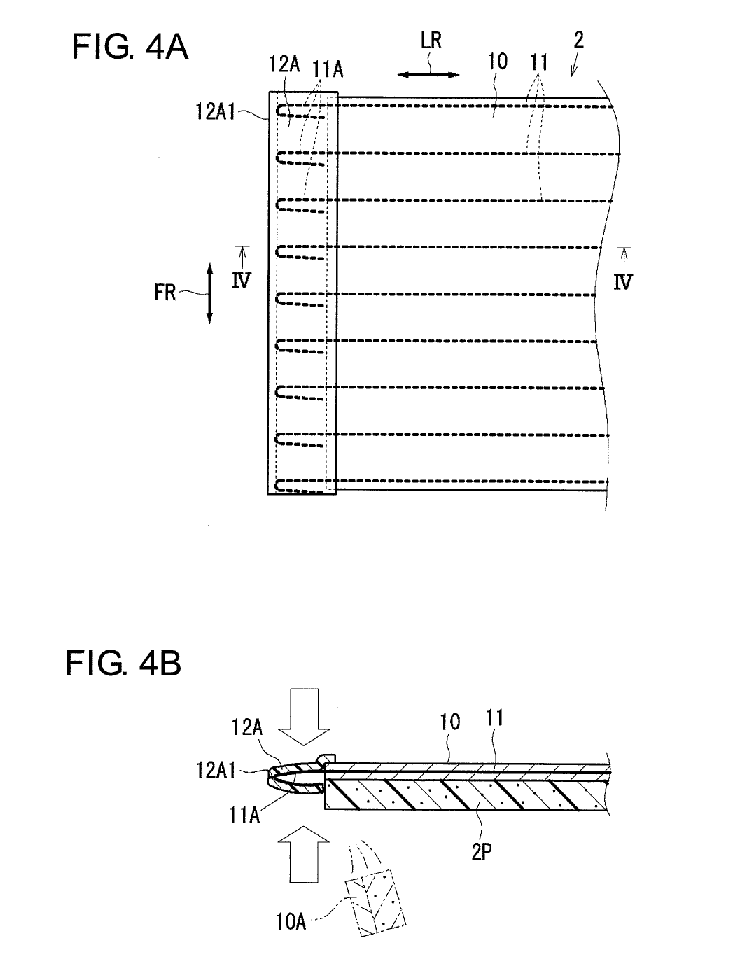

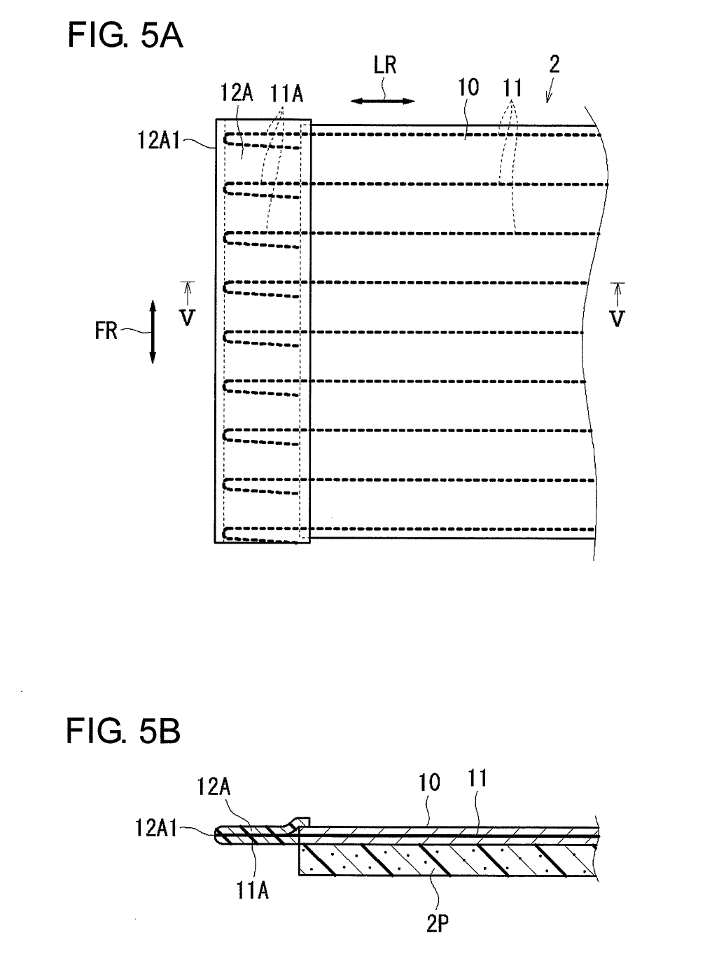

Then, as shown in FIGS. 3A and 3B, a flexible connecting member 12A of a strip shape (long plane shape) having conductivity is put on upper surfaces of the exposed parts 11A of the conductive wires 11 and is then folded in a width direction so as to sandwich the respective exposed parts 11A therebetween, as shown in FIGS. 4A, 4B, 5A and 5B. Then, the connecting member 12A is integrally fused and surface-adhered with the respective exposed parts 11A, so that the exposed parts 11A are inserted in a lump, integrally adhered and electrically connected to the connecting member 12A. The connecting member 12A is configured by inserting a plurality of conductive threads into the braided false twist yarns of polyethylene terephthalate (PET), which are the same as the cloth member 10. In the meantime, the connecting member 12A may also be configured by inserting a plurality of conductive threads into woven fabrics, knitted materials, nonwoven fabrics or braids made of wires of various insulating fibers or may be leather.

The connecting member 12A is integrally adhered to the respective exposed parts 11A with being electrically connected in such a manner of folding the connecting member 12A in the seat width direction LR (longitudinal direction of the conductive wires 11) to sandwich the exposed parts 11A of the respective conductive wires 11 in a lump above and below and fusing the folded surfaces by some heating means with the respective conductive threads being contacted to the respective exposed parts 11A of the conductive wires 11, thereby surface-adhering with the respective exposed parts 11A. In the meantime, the means for surface-adhering the folded surfaces of the connecting members 12A may include various adhering means such as stitching and adhesive, in addition to the above fusion.

Specifically, as shown in FIG. 3A and 3B, the connecting member 12A is integrally fused to the main body part of the cloth member 10 while a right edge, which will be an inner side of the seat, is provided on the edge of the main body part. Thereby, the connecting member 12A is integrally fixed to the cloth member 10, so that the electrical connection with the exposed parts 11A of the respective conductive wires 11 is kept more stable. The connecting member 12A is formed with a folding line 12A1 at a center part thereof in a width direction before the folding. The folding line 12A1 is formed by stitching the connecting member over the entire longitudinal area thereof and straightly extends in the longitudinal direction. By the folding line 12A1, the connecting member 12A can be easily folded about the folding line 12A1 so that the folding line becomes straight.

The exposed part 11A of each conductive wire 11 is folded back into a U-shape between the folded surfaces of the connecting member 12A so that a protruding degree (length) of the exposed part is reduced in the seat width direction LR (refer to FIG. 4). That is, the protruding degree of each exposed part 11A in the seat width direction LR is suppressed. Accordingly, even when each exposed part 11A is lengthened to secure a wider contact area with the connecting member 12A, it is possible to make the size (entire folded length) in the seat width direction LR, which is required for the connecting member 12A, smaller and thus to compactly arrange the connecting member 12A to the cloth member 10 in the seat width direction LR. In the meantime, the folded shape of each exposed part 11A is not limited to the U-shape. However, when each exposed part were folded into an L shape, for example, an overlapping with the neighboring exposed part 11A might be caused. If the overlapping or contact is caused, stress is applied to the overlapping portion which causes breakage of wires or applied current becomes uneven among the wires, which causes unexpected operation. Thus, it is preferable to fold the exposed part so that the overlapping or contact is not caused.

In surface-adhering of the folded surfaces of the connecting member 12A each other, the edge part 10A of the cloth member 10 connected to the leading end of each exposed part 11A is cut together with the pad material 2P of the backside of the same part, so that the connecting member 12A is surface-adhered in a compact and light state. Thereby, the electrical connection between the connecting member 12A and the exposed part 11A of each conductive wire 11 is kept more stable (refer to FIGS. 5A and 5B). The connecting member 12A and each exposed part 11A may be integrally connected such that the folded surfaces are surface-adhered only at the arranged position of each exposed part 11A, rather than that all areas of the folded surfaces of the connecting member 12A are adhered. Thereby, the connecting member 12A is adhered and cured only at the arranged position of each exposed part 11A, not the entire area of the connecting member 12A. Therefore, the area in which the seating feeling is lowered due to the curing of the connecting member 12A can be suppressed.

As shown in FIG. 2, the connecting members 12A that are electrically connected to the exposed parts 11A of the respective conductive wires 11 are electrically connected with power cables 12B, respectively. The power cables 12B are electrically connected to a positive terminal or a negative terminal of a direct current power source (not shown), respectively. By the electrical connection, the respective conductive wires 11 are electrically connected to configure a parallel circuit in which the conductive wires are arranged in parallel with respect to the direct current power source. Thereby, the respective conductive wires 11 are enabled to conduct the electric current and to generate heat with a relatively low voltage.

According to the cloth member 10 of this illustrative embodiment, the folded surfaces of the connecting members 12A, which are folded to sandwich the exposed parts 11A of the respective conductive wires 11 therebetween, are integrally surface-adhered, so that the wide adhering surface is secured. As a result, the adhering state, in which the respective exposed parts 11A are sandwiched between the folded surfaces, becomes stable. Accordingly, it is possible to electrically connect the connecting member 12A and the respective conductive wires 11 so that the connection resistance therebetween can be reduced. In addition, the connecting member 12A has such an elongated shape that the connecting member is provided over the exposed parts 11A of the conductive wires 11. Thus, the connecting member is folded in the direction (seat width direction LR) at which the peak resulting from the folding is positioned at the end portion of each exposed part 11A, and is integrally surface-adhered with the respective exposed parts 11A. Accordingly, compared to a configuration where the connecting members 12A are folded and are surface-adhered in the direction (front and rear direction FT of the seat) along which the conductive wires 11 are arranged, it is possible to fold the connecting members 12A in a smaller space and to electrically connect the exposed parts 11A of the respective conductive wires 11 in a lump. In addition, the exposed part 11A of each conductive wire 11 is folded back between the folded surfaces of the connecting member 12A so that the protruding degree (length) in the seat width direction LR is reduced. Thus, even when each exposed part 11A is lengthened to secure a wide contact area with the connecting member 12A, it is possible to make the entire folded length, which is required for the connecting member 12A, small and thus to compactly arrange the connecting member 12A to the cloth member 10.

### Second Illustrative Embodiment

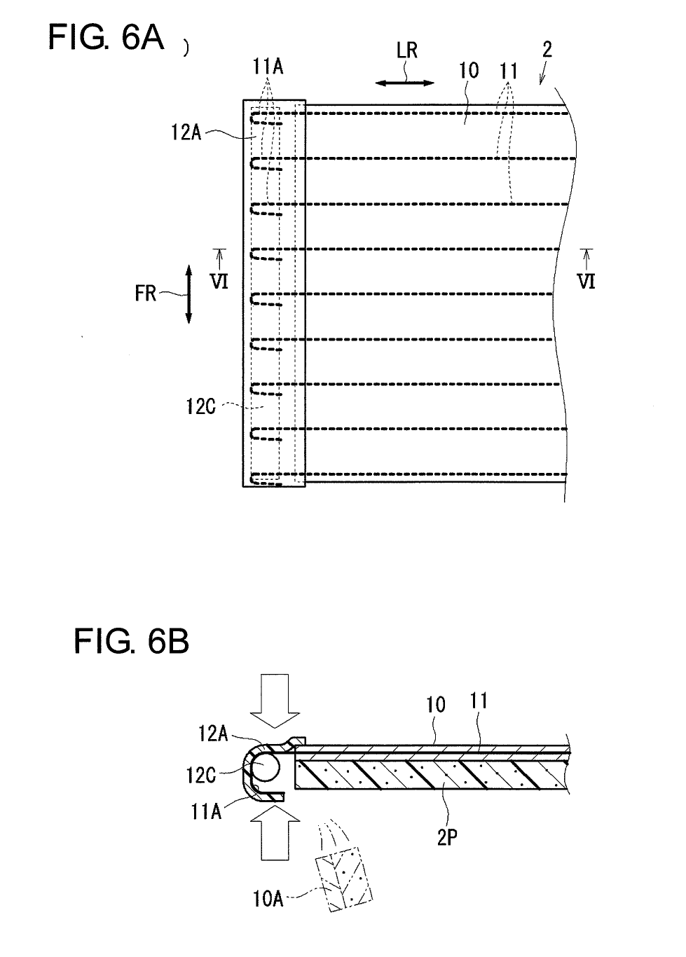

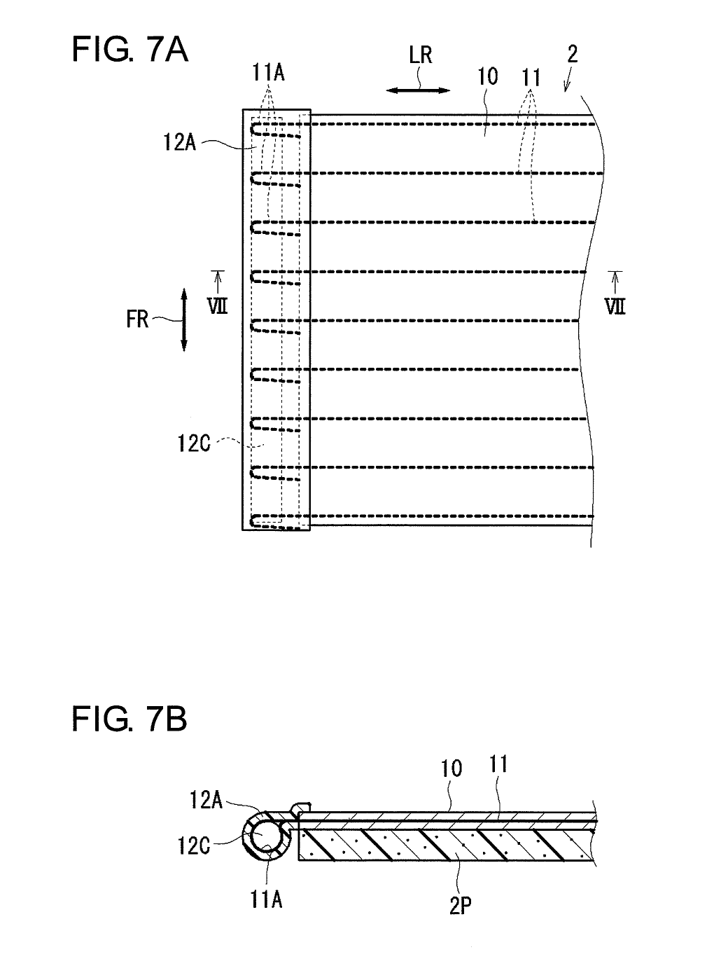

A configuration of the cloth member 10 of a second illustrative embodiment will be described with reference to FIGS. 6A, 6B, 7A and 7B. In this illustrative embodiment, the substantially same constitutional elements as the cloth member 10 of the first illustrative embodiment are indicated with the same reference numerals and the descriptions thereof are omitted, and the different constitutional elements are indicated with different reference numerals and will be specifically described.

As shown in FIGS. 6A, 6B, 7A and 7B, the cloth member 10 of this illustrative embodiment has a circular rod-shaped interposed member 12C having conductivity between the surfaces of the connecting member 12A, which are folded and to be surface-adhered. In this illustrative embodiment, the interposed member 12C is configured by an elastic member having conductivity such as rubber. However, the interposed member 12C may be configured by a member having no conductivity or elasticity. When the interposed member 12C is configured by a member having conductivity, it is possible to further reduce the electrical connection resistance between the connecting member 12A and each exposed part 11A by the contact of the interposed member 12C to the connecting member 12A and each exposed part 11A. In addition, when the interposed member 12C is configured by a member having elasticity, elastically repulsive force of pressing each exposed part 11A to the inner circumferential surface of the connecting member 12A is applied. Thus, the compressing force between each exposed part 11A and the connecting member 12A is increased to electrically connect each exposed part and the connecting member so that the connection resistance is further decreased. In addition, even when the interposed member 12C is not configured by of a member having elasticity, by the pressing force of the interposed member 12C to the inner circumferential surface of the connecting member 12A with the surface-adhering force of the connecting member 12A, the respective exposed parts 11A are pressed to the inner circumferential surface of the connecting member 12A to increase the compressing force between the respective exposed parts 11A and the connecting member 12A. As a result, it is possible to electrically connect each exposed part and the connecting member so that the connection resistance is further decreased.

While the present invention has been shown and described with reference to certain exemplary embodiments thereof, it will be understood by those skilled in the art that various changes in form and details may be made therein without departing from the spirit and scope of the invention as defined by the appended claims.

In the illustrative embodiments, the cloth member 10 that is used as the covering material of the seat cushion 2 of the vehicle seat 1 has been exemplified.

However, the cloth member may be also used as a covering material of a part to which an occupant contacts, such as seatback 3, headrest and ottoman. In addition, the cloth member of the present invention is not limited to the case where it is applied to the covering material of a vehicle seat, and can be applied to various cloth members that are used to provide an occupant with a warming feeling. In addition, the number of conductive wire provided in the cloth member may be at least one and the number is not particularly limited. Additionally, the arranging direction of the conductive wire to the cloth member and the position at which the exposed part is exposed are not particularly limited and can be freely set depending on the using purposes thereof as long as the conductive wire is provided with an exposed part exposed from the cloth member to the outside in the longitudinal direction.

What is claimed is:

1. A cloth member comprising:
a conductive wire configured to generate heat by applying electric current; and
a plane-shaped connecting member having conductivity,
wherein the conductive wire has an exposed part that is exposed to an outside from the cloth member at a part in a longitudinal direction of the wire, and
wherein the place-shaped connecting member is folded to sandwich the exposed part of the conductive wire therebetween such that folded surfaces of the connecting member are surface-adhered with each other integrally with the exposed part to be electrically connected to the exposed part.

2. The cloth member according to claim 1,
herein a plurality of conductive wires are aligned in a specific direction within a plane of the cloth member, each conductive wire having an exposed part exposed from an edge part of the cloth member, and
wherein the plane-shaped connecting member extends over the respective exposed parts of the conductive wires and is folded in the longitudinal direction of the respective conductive wires such that the folded surfaces of the connecting member are surface-adhered with each other integrally with the respective exposed parts of the conductive wires to be electrically connected to the exposed parts.

3. The cloth member according to claim 1,
wherein the exposed part of the conductive wire is folded back between the folded surfaces of the connecting member such that a length of the exposed part in the longitudinal direction is reduced.

4. The cloth member according to claim 1,
wherein the conductive wire is inserted into the cloth member.

5. The cloth member according to claim 1,
wherein the plane-shaped connecting member has a folding line by stitching the connecting member.
